(19) United States
(12) Patent Application Publication
(10) Pub. No.: US 2003/0095080 A1
(43) Pub. Date: May 22, 2003

(54) Method and system for improving car safety using image-enhancement

(75) Inventors: Antonio Jose Colmenarez, Maracaibo (VE); Srinivas Gutta, Yorktown Heights, NY (US); Miroslav Trajkovic, Ossining, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/988,948

(22) Filed: Nov. 19, 2001

(51) Int. Cl. G09G 5/00

(52) U.S. Cl. 345/7

(57) ABSTRACT

System and method for displaying a driving scene to a driver of an automobile. The system comprises at least one camera having a field of view and facing in the forward direction of the automobile. The camera captures images of the driving scene, the images comprised of pixels of the field of view in front of the automobile. A control unit receives the images from the camera and applies a salt and pepper noise filtering to the pixels comprising the received images. The filtering improves the quality of the image of the driving scene received from the camera when degraded by a weather condition. A display receives the images from the control unit after application of the filtering operation and displays the images of the driving scene to the driver.

### FIELD OF THE INVENTION

The invention relates to automobiles and, in particular, to a system and method for processing various images and providing an improved view to drivers under adverse weather conditions.

### BACKGROUND OF THE INVENTION

Much of today's driving occurs in a demanding environment. The proliferation of automobiles and resulting traffic density has increased the amount of external stimulii that a driver must react to while driving. In addition, today's driver must often perceive, process and react to a driving condition in a lesser amount of time. For example, speeding and/or aggressive drivers give themselves little time to react to a changing condition (e.g., a pothole in the road, a sudden change of lane of a nearby car, etc.) and also give nearby drivers little time to react to them.

In addition to confronting such demanding driving conditions on an everyday basis, drivers are also often forced to drive under extremely challenging weather conditions. A typical example is the onset of a snow storm, where visibility may be suddenly and severely impeded. Other examples include heavy rain and sun glare, where visibility may be similarly impeded. Despite advancements in digital signal processing technologies, including computer vision, pattern recognition, image processing and artificial intelligence (AI), little has been done to assist drivers with the highly demanding decision-making involved when environmental conditions provide an impediment to normal vision.

One driver aid system currently available, in the Cadillac DeVille, military “Night Vision” is adapted to detect objects in front of the automobile at night. Heat in the form of high emission of infrared radiation from humans, other animals and cars in front of the car is captured using cameras (focusing optics) and focused on an infrared detector. The detected infrared radiation data is transferred to processing electronics and used to form a monochromatic image of the object. The image of the object is projected by a head-up display near the front edge of the hood in the driver's peripheral vision. At night, objects that may be outside the range of the automobiles headlights may thus be detected in advance and projected via the heads-up display. The system is described in more detail in the document “DeVille Becomes First Car To Offer Safety Benefits Of Night Vision” at http://www.gm.com/company/gmability/safety/crash_avoidance/newfeatures/night_vision.html.

The DeVille Night Vision system would likely be degraded or completely impeded in severe weather, because the infrared light emitted would be blocked or absorbed by the snow or rain. Even if it did operate to detect and display such objects in a snow storm, rain storm, or other severe weather condition, among other deficiencies of the DeVille Night Vision system, the display only provides the thermal image of the object (which must be sufficiently “hot” to be detected via the infrared sensor), and the driver is left to identify what the object is by the contour of the thermal image. The driver may not be able to identify the object. For example, the thermal contour of a person walking hunched over with a backpack may be too alien for a driver to readily discern via a thermal image. The mere presence of such an unidentifiable object may also be distracting. Finally, it is difficult for the driver to judge the relative position of the object in the actual environment, since the thermal image of the object is displayed near the front edge of the hood without reference to other non-thermally emitting objects.

A method of detecting pedestrians and traffic signs and then informing the driver of certain potential hazards (a collision with a pedestrian, speeding, or turning the wrong way down a one-way street) is described in “Real-Time Object Detection For “Smart” Vehicles” by D. M. Gavrila and V. Philomin, Proceedings of IEEE International Conference On Computer Vision, Kerkyra, Greece 1999 (available at www.gavrila.net), the contents of which are hereby incorporated by reference herein. A template hierarchy captures a variety of object shapes, and matching is achieved using a variant of Distance Transform based-matching, that uses a simultaneous coarse-to-fine approach over the shape hierarchy and over the transformation parameters.

A method of detecting pedestrians on-board a moving vehicle is also described in “Pedestrian Detection From A Moving Vehicle” by D. M. Gavrila, Proceedings Of The European Conference On Computer Vision, Dublin, Ireland, 2000, the contents of which are hereby incorporated by reference herein. The method builds on the template hierarchy and matching using the coarse-to-fine approach described above, and then utilizes Radial Basis Functions (RBFs) to attempt to verify whether the shapes and objects are pedestrians.

In both of the above-referenced articles, however, the identification of an object in the image will deteriorate under adverse weather conditions. In a snowstorm, for example, the normal contrast of objects and features in the image are obscured by the addition of an overall layer of brightness to the image by the falling snow. In the case of falling snow, light is scattered off each falling snowflake in myriad directions, thus obscuring elements (or data) of the scene from a camera capturing an image of the scene. Although the drops comprising falling rain is partially translucent, it still has the effect of obscuring elements of the scene from a camera capturing images of the scene. This has the effect of degrading or incapacitating the template matching and RBF techniques, which rely on detecting the image gradient provided by the borders of objects in the image.

### SUMMARY OF THE INVENTION

The prior art fails to provide a system that operates to improve images of a driving scene displayed for a driver when the automobile is being operated in adverse weather conditions, that is, when normal visibility of the driver is degraded or obscured by the weather conditions. The prior art fails to use certain image processing, either alone or together with additional image recognition processing to improve images of a driving scene to clearly project, for example, objects in or adjacent the roadway, traffic signals, traffic signs, road contours and road obstructions. The prior art also fails to present a recognizable image of the driving scene (or objects and features thereof) to the driver in an intelligible manner when the automobile is being operated in adverse weather conditions.

It is thus an objective of the invention to provide a system and method for displaying an improved image of a driving scene to a driver of an automobile, where the actual image seen by the driver is degraded by weather conditions. The system comprises at least one camera having a field of view and facing in the forward direction of the automobile. The camera captures images of the driving scene, the images comprised of pixels of the field of view in front of the automobile. A control unit receives the images from the camera and applies a salt and pepper noise filtering to the pixels comprising the received images. The filtering improves the quality of the image of the driving scene received from the camera when degraded by a weather condition. A display receives the images from the control unit after application of the filtering operation and displays the images of the driving scene to the driver.

The control unit may further apply a histogram equalization operation to the intensities of the pixels comprising the filtered image prior to display. The histogram equalization operation further improving the quality of the image of the driving scene when degraded by the weather condition. The control unit may further apply image recognition processing to the image following the histogram equalization operation and prior to display.

In the method of displaying a driving scene to a driver of an automobile, images of the driving scene in the forward direction of the automobile are captured. The images are comprised of pixels of the field of view in front of the automobile. Salt and pepper noise filtering is applied to the pixels comprising the captured images. The filtering improves the quality of the images of the driving scene captured when degraded by a weather condition. The images of the driving scene are displayed to the driver after application of the filtering operation.

### BRIEF DESCRIPTION OF THE DRAWINGS

FIG. 1 is a side view of an automobile that incorporates an embodiment of the invention;

FIG. 1a is a top view of the automobile of FIG. 1;

FIG. 2 is a representative drawing of components of the embodiment of FIGS. 1 and 1a and other salient features used to describe the embodiment;

FIG. 3a is a representative image generated by the camera of the embodiment of FIGS. 1-2 when the weather conditions are not severe or, alternatively, with the application of certain inventive image processing techniques when the weather is severe;

FIG. 3b is a representative image generated by the camera of the embodiment FIGS. 1-2 without the application of certain inventive image processing techniques when the weather is severe;

FIG. 4a is a representation of a pixel in an image to be filtered and the neighboring pixels used in the filtering;

FIG. 4b is representative of steps applied in the filtering of the pixel of FIG. 4a;

FIG. 5a is a representative histogram of the image of FIG. 3b after filtering; and

FIG. 5b is the histogram of the image of FIG. 3b after application of histogram equalization.

### DETAILED DESCRIPTION

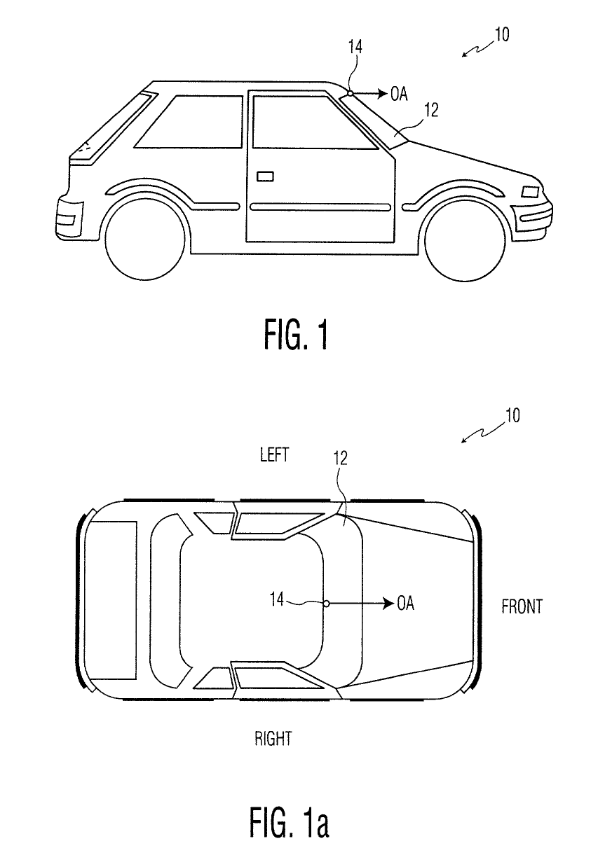

Referring to FIG. 1, an automobile 10 is shown that incorporates an embodiment of the invention. As shown, camera 14 is located at the top of the windshield 12 with its optic axis pointing in the forward direction of the automobile 10. The optic axis (OA) of camera 14 is substantially level to the ground and substantially centered with respect to the driver and passenger positions, as shown in FIG. 1a. Camera 14 captures images in front of the automobile 10. The field of view of camera 14 is preferably on the order of 180°, thus the camera captures substantially the entire image in front of the auto. The field of view, however, may be less than 180°.

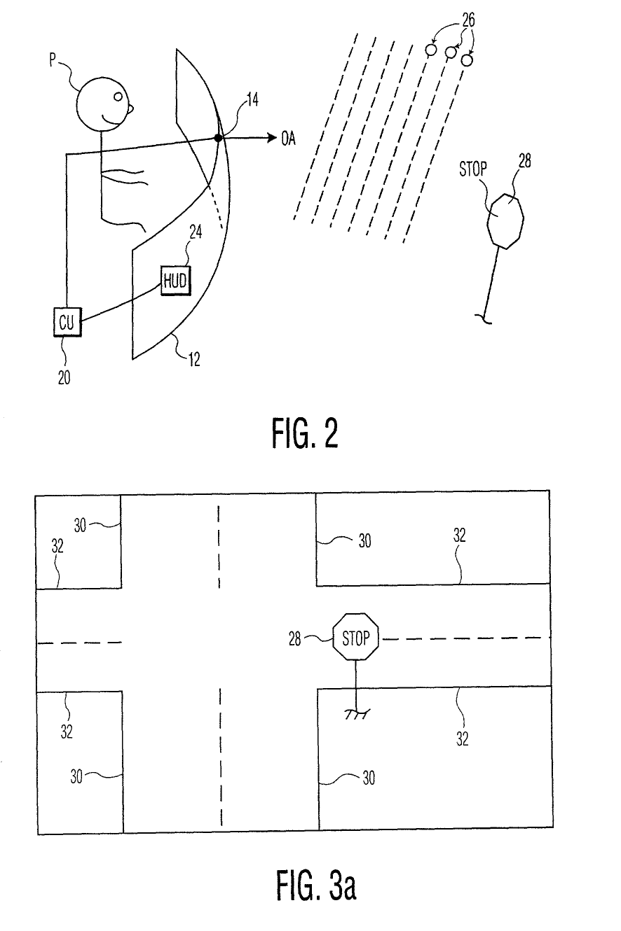

Referring to FIG. 2, additional components of the system that support the embodiment of the invention, as well as the relative positions of the components and the driver P are shown. FIG. 2 shows the position of the driver's P head in its relative position on the left hand side, behind the windshield 12. Camera 14 is located at the top center portion of the windshield 12, as described above with respect to FIGS. 1 and 1a. In addition, snow comprised of snowflakes 26 are shown that at least partially obscures the driver's P view outside the windshield 12. The snowflakes 26 partially obscure the driver's P view of the roadway and other traffic objects and features (collectively, the driving scene), including stop sign 28. As will be described in more detail below, images from camera 14 are transmitted to control unit 20. After processing the image, control unit 20 sends control signals to head-up display (HUD) 24, as also described further below.

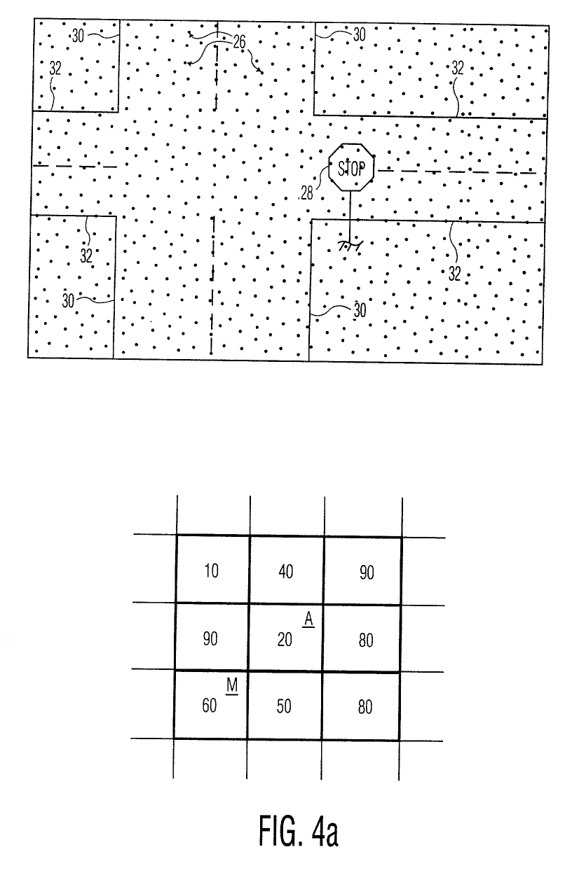

Referring to FIG. 3a, the driving scene as seen by the driver P through windshield 12 at a point in time without the effects of the snow 26 is shown. In particular, the boundaries of roadways 30, 32 that intersect and a stop sign 28 are shown. The scene of FIG. 3a is substantially the same as the images received by control unit 20 (FIG. 2) at a point in time from camera 14 without the obscuring snowflakes 26.

FIG. 3b shows the driving scene as seen by the driver P (and as captured by the images of camera 14) when snowflakes 26 are present. In general, snow scatters light incident on the individual flakes in every direction, thus leading to a general “whitening” of the image. This results in a lessening of the contrast between the objects and features of the image, such as the road boundaries 30, 32 and the stop sign 28 (represented in FIG. 3b by fainter outlines). In addition to generally brightening the image, the individual snowflakes 26 (especially during a heavy downfall) physically obscure elements behind them in the scene from the driver P and the camera 14 capturing an image of the scene. Thus, the snowflakes 26 block image data of the scene from the camera 14.

Control unit 20 is programmed with processing software that improves images received from camera 12 that is obscured due to weather conditions, such as that shown in FIG. 3b. The processing software first treats the snowflakes 26 in the image as “salt and pepper” noise. Salt and pepper noise is alternatively referred to as “data drop-out” noise or “speckle”. Salt and pepper noise often results from faulty transmission of image data, which randomly creates corrupted pixels throughout the image. The corrupted pixels may have a maximum value (which looks like snow in the image), or may be alternatively set to either zero or the maximum value (thus giving the name “salt and pepper”). Uncorrupted pixels in the image retain their original image data. However, the corrupted pixels contain no information about their original values. Additional description of salt and pepper noise is given at http://www.dai.ed.ac.uk/HIPR2/noise.htm.

An image that is actually blanketed with snowflakes is thus considered in the inventive method and processing as the “snow” in an image that has pixels corrupted by salt and pepper noise such that the corrupted pixels take on a maximum value. Control unit 20 therefore applies filtering that is directed at removing salt and pepper noise to the images as received from camera 14. In one exemplary embodiment, the control unit 20 applies median filtering, which replaces each pixel value with the median gray value of pixels in the local neighborhood. Median filtering does not use an average or weighted sum of the values of neighboring pixels, as in linear filtering. Instead, for each pixel treated, the median filter considers the gray values of the pixel and a neighborhood of surrounding pixels. The pixels are sorted according to gray value (by either ascending or descending gray value) and the median pixel in the order is selected. In the typical case, the number of pixels considered (including the pixel being treated) is odd. Thus, for the median pixel selected, there are an equal number of pixels having higher and lower gray value. The gray value of the median pixel replaces the pixel being treated.

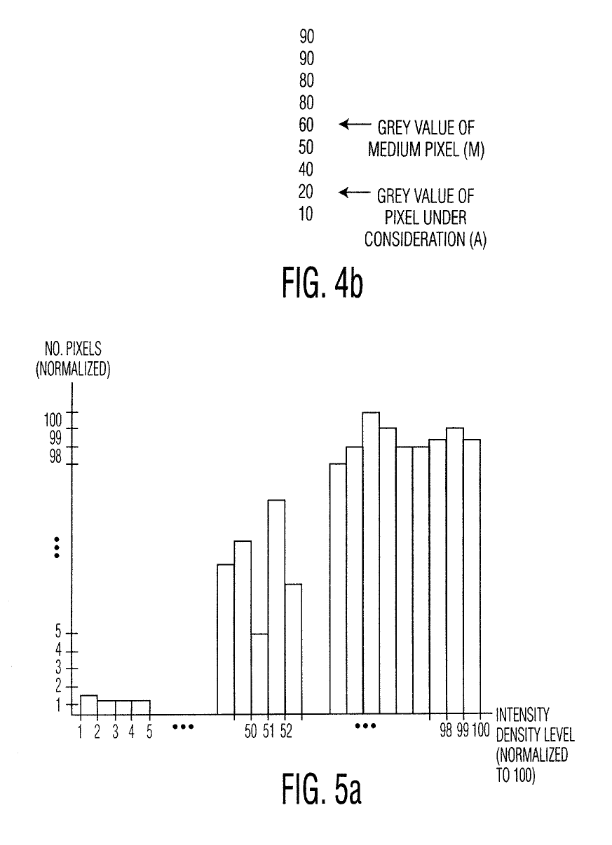

FIG. 4a is an example of median filtering as applied to a pixel A of an image array being subjected to filtering. Pixel A and the immediately surrounding pixels are used as the neighborhood in the median filtering. Thus, the gray values (shown in FIG. 4a for each pixel) of nine pixels are used for filtering the pixel A under consideration. As shown in FIG. 4b, the gray values of the nine pixels are sorted according to gray value. As seen, the median pixel of the sorting is pixel M in FIG. 4b, since four pixels have a higher gray value and four have a lower gray value. The filtering of pixel A thus replaces the gray value of 20 with the gray value 60 of the median pixel.

As noted, in the typical case, there is one median pixel because an odd number of pixels are considered for the pixel being treated. If a neighborhood is selected such that an even number of pixels are considered, then the average gray value of the two middle pixels as sorted may be used. (For example, if ten pixels are considered, the average gray value of the fifth and sixth pixels as sorted may be used.)

Such median filtering is effective in removing salt and pepper noise from an image while retaining the details of the image. Use of the gray value of the median pixel maintains the filtered pixel value equal to that of a gray value of a pixel in the neighborhood, thus maintaining image details that may be lost if the gray values themselves of the neighborhood pixels are averaged.

Thus, as noted, in the first exemplary embodiment of filtering to remove salt and pepper filtering, the control unit 20 applies median filtering to each pixel comprising the image received from camera 14. A neighborhood of pixels (for example, of the eight immediately adjacent pixels, as shown in FIG. 4a) is considered for each pixel comprising the image to conduct the median filtering, as described above. (For edges of the image, those portions of the neighborhood that are present may be used.) The median filtering reduces or eliminates salt and pepper noise from the image, and thus effectively reduces or eliminates the snowflakes 26 from the image of the driving scene received from camera 14.

In a second exemplary embodiment of filtering to remove salt and pepper filtering, the control unit 20 applies “Smallest Univalue Segment Assimilating Nucleus” (“SUSAN) filtering to each pixel comprising the image received from camera 14. For SUSAN filtering, a mask is created for the pixel being treated (the “nucleus”) that delineates a region of the image having the same or similar brightness as the nucleus. This mask region of the image for the nucleus (pixel being treated) is referred to as the USAN (“Univalue Segment Assimilating Nucleus”) area. SUSAN filtering proceeds by computing a weighted average gray value of pixels that lie within the USAN (excluding the nucleus) and substituting the averaged value for the value of the nucleus. Using the gray values of pixels within the USAN ensures that pixels used in averaging will be from related regions of the image, thus preserving the structure of the image while eliminating the salt and pepper noise. Further details of SUSAN processing and filtering are given in “SUSAN—A New Approach To Low Level Image Processing” by S. M. Smith and J. M. Brady, Technical Report TR95SMS1c, Defence Research Agency, Farnborough, England (1995) (also appears in Int. Journal Of Computer Vision, 23(1):45-78 (May 1997)), the contents of which are hereby incorporated by reference herein.

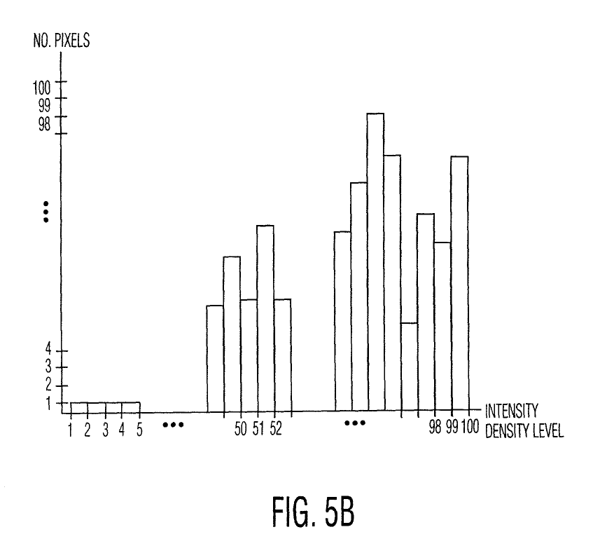

Once the image is filtered to remove salt and pepper noise (and thus the snowflakes 26 in the image), the filtered image may be immediately output by control unit 20 to the HUD 24 for display to driver P, in the manner described further below. As noted, however, the snowflakes 26 can also provide a general brightening to the image of the scene which can reduce the contrast of features and objects in the image. Thus, control unit 20 alternatively applies a histogram equalization algorithm to the filtered images. Techniques of histogram equalization are well-known in the art and improve the contrast of an image without affecting the structure of the information contained therein. (For example, they are often used as a pre-processing step in image recognition processing.) For the image of FIG. 3b, even after the snowflakes 26 are filtered from the image, the faint contrast of the stop sign 28 and road boundaries 30, 32 may remain in the image. The histogram of the image pixels of the image of FIG. 3b after salt and pepper filtering to remove the snowflakes 26 is represented in FIG. 5a. As seen, there are a large number of pixels in the image that have a high intensity level, representing a large number of pixels having a higher brightness. After application of a histogram equalization operation to the image, the histogram is represented in FIG. 5b. The operator maps all pixels of an (input) intensity in the original image to another (output) intensity in the output image. The intensity density level is thereby “spread-out” by the histogram equalization operator, thus providing improved contrast to the image. However, since only the intensities assigned to the features of the image are adjusted, the operation does not change the structure of the image.

A typical histogram equalization transformation function used to map an input image A to an output image B is given as:

$$f ( {D}_{A} ) = ( {D}_{M} ) * {\int }_{0}^{{D}_{A}} {p}_{A} ( u ) ⅆ u \qquad Eq . 1$$

where p is the assumed probability function that describes the intensity distribution of the input image A, which is assumed to be random, D_{A} is the particular intensity level of the original image A under consideration, and D_{M} is the maximum number of intensity levels in the input image. Consequently,

ƒ(D_{A})=D_{M}*F_{A}(D_{A}) Eq. 2

where F_{A}(D_{A}) is the cumulative probability distribution (that is, the cumulative histogram) of the original image up to the particular intensity level D_{A}. Thus, using this histogram operation, namely, an image which is transformed using its cumulative histogram, the result is a flat output histogram. This is a fully equalized output image.

An alternative histogram equalization operation that is particularly suited for digital implementations uses the transformation function:

ƒ(D_{A})=max(0, round[D_{M}*nₖ/N²)]−1) Eq. 3

where N is the number of image pixels, and nₖ is the number of pixels at intensity level k (=D_{A}) or less. All pixels in the input image having intensity level D_{A} (or k) are mapped to the intensity level ƒ(D_{A}). While the output image is not necessarily fully equalized (there may be holes or unused intensity levels in the histogram), the intensity density of the pixels of the original image are spread more equally over the output image, especially if the number of pixels and the intensity quantization level of the input image is high. Histogram equalization as summarized above is described in more detail in the publication “Histogram Equalization”, R. Fisher, et al., Hypermedia Image Processing Reference 2, Department of Artificial Intelligence, University of Edinburgh (2000), published at www.dai.ed.ac.uk/HIPR2/histeq.htm, the contents of which are hereby incorporated by reference herein.

When histogram equalization is applied, control unit 20 applies the operator of Eq. 3 (or alternatively, Eq. 2) to the pixels that comprise the image received from camera 14 as previously filtered by the control unit 20. This re-assigns (maps) the intensity of each pixel in the input image (having a particular intensity D_{A}) to intensity given by ƒ(D_{A}). The quality of the image, including the contrast in the filtered and equalized image created within control unit 20, is significantly improved and approaches the quality of an image that is not affected by the weather condition, such as that shown in FIG. 3a. (For convenience, the image rendered within the control unit 20 after filtering and histogram equalization is referred to as the “pre-processed image”.) In that case, the pre-processed image created within the control unit 20 is directly displayed on a region of the windshield 12 via HUD 24. The HUD 24 projects the pre-processed image in a small unobtrusive region of the windshield 12 (for example, below the driver's P normal gaze point out of the windshield 12), thus displaying an image of the driving scene that is clear of the weather condition.

In addition, the pre-processed image created by the control unit 20 from the input image received from the camera 14 is improved to the degree that image recognition processing can be reliably applied to the pre-processed image by the control unit 20. Either the driver (through an interface) may initiate image recognition processing by the control unit 20, or the control unit 20 itself may automatically apply it to the pre-processed image. The control unit 20 applies image recognition processing to further analyze the pre-processed image rendered within control unit 20. Control unit 20 is programmed with image recognition software that analyzes the pre-processed image and detects therein traffic signs, human bodies, other automobiles, the boundaries of the roadway and objects or deformations in the roadway, among other things. Because the pre-processed image has improved clarity and contrast with respect to the original image received from camera 12 (which is degraded due to the weather condition, as discussed above), the image recognition processing performed by the control unit 20 has a high level of image detection and recognition.

The image recognition software may incorporate, for example, the shape-based object detection described in the “Real-Time Object Detection for “Smart” Vehicles” noted above. Among other objects, the control unit 20 is programmed to identify the shapes of various traffic signs in the pre-processed image, such as the stop sign 28 in FIGS. 3a and 3b. Similarly, the control unit 20 may be programmed to detect the contour of a traffic signal in the pre-processed image and to also analyze the current color state of the signal (red, amber or green). In addition, the image gradient of the borders of the road may be detected as a “shape” in the pre-processed image by the control unit 20 using the template method in the shape-based object detection technique described in “Real-Time Object Detection for “Smart” Vehicles”.

In general, control unit 20 analyzes a succession of pre-processed images (which have been generated using the received images from camera 12) and identifies the traffic signs, roadway contour, etc. in each such image. All of the images may be analyzed or a sample may be analyzed over time. Each image may be analyzed independently of prior images. In that case, a stop sign (for example) is independently identified in a current image received even if it had previously been detected in a prior image received.

After detecting pertinent traffic objects (such as traffic signs and signals) and features (such as roadway contours) in the pre-processed image, control unit 20 enhances those features in the image output for the HUD 24. Enhancement may include, for example, improvement of the quality of the image of those objects and features in the output image. For example, in the case of a stop sign, the word “stop” in the pre-processed image still may be partially or completely illegible due to the snow or other weather condition. However, the pre-processed image of the octagonal border of the stop sign may be sufficiently clear to enable the image recognition processing to identify it as a stop sign. In that case, control unit 20 enhances the image transferred to the HUD 24 for projection by digitally incorporating the word “stop” in the correct position in the image of the sign. In addition, the proper color to the sign may be added if it is obscured in the pre-processed image. Enhancement may also include, for example, digitally highlighting aspects of the objects and features identified by the control unit 20 in the pre-processed image. For example, after identifying a stop sign in the pre-processed image, the control unit 20 may highlight the octagonal border of the stop sign using a color that has a high contrast with the immediately surrounding region. When the image is projected by the HUD 24, the driver P will naturally shift his attention to such highlighted objects and features.

If an object is identified in an pre-processed image as being a control signal, traffic sign, etc., control unit 20 may be further programmed to track its movement in subsequently pre-processed images, instead of independently identifying it anew in each subsequent image. Tracking the motion of an identified object in successive images based on position, motion and shape may rely, for example, on the clustering technique described in “Tracking Faces” by McKenna and Gong, Proceedings of the Second International Conference on Automatic Face and Gesture Recognition, Killington, Vt., Oct. 14-16, 1996, pp. 271-276, the contents of which are hereby incorporated by reference. (Section 2 of the aforementioned paper describes tracking of multiple motions.) By tracking the motion of an object between images, control unit 20 may reduce the amount of processing time required to present an image having enhanced features to the HUD 24.

As noted above, the control unit 20 of the above-described embodiment of the invention may also be programmed to detect objects that are themselves moving in the pre-processed images, such as pedestrians and other automobiles and to enhance those objects in the image sent to and projected by the HUD 24. Where pedestrians and other objects in motion are to be detected (along with traffic signals, traffic signs, etc.), control unit 20 is programmed with the identification technique as described in “Pedestrian Detection From A Moving Vehicle”. As noted, this provides a two step approach for pedestrian detection that employs an RBF classification as the second step. The template matching of the first step and the training of the RBF classifier in the second step may also include automobiles, thus control unit 20 is programmed to identify pedestrians and automobiles in the received images. (The programming may also include templates and RBF training for the stationary traffic signs, signals, roadway boundaries, etc. focused on above, thus providing the entirety of the image recognition processing of the control unit 20.) Once an object is identified as a pedestrian, other automobile, etc. by control unit 20, its movement may be tracked in subsequent images using the clustering technique as described in “Tracking Faces”, noted above.

In the same manner as described above, the automobile or pedestrian identified in the pre-processed image is enhanced by the control unit 20 for projection by the HUD 24. Such enhancement may include digital adjustment of the borders of the image of the pedestrian or automobile to render them more recognizable to the driver P. Enhancement may also include, for example, digitally adjusting the color of the pedestrian or automobile so that it contrasts better with the immediately surrounding region in the image. Enhancement may also include, for example, digitally highlighting the borders of the pedestrian or automobile in the image, such as with a color that contrasts markedly with the immediately surrounding region, or by flashing the borders. Again, when the image having the enhancements is projected by the HUD 24, the driver P will naturally shift his attention to such highlighted objects and features.

As noted, instead of the driver P initiating the image recognition processing within the control unit 20, the image recognition processing may always be performed on the pre-processed image. This eliminates the need for the driver to engage the additional processing. Alternatively, the control unit 20 may interface with external sensors (not shown) on the automobile that supply input signals that indicate the nature and degree of severity of the weather. Based on the indicium of the weather received from the external sensors, the control unit 20 chooses whether or not to employ the processing described above that creates and displays the pre-processed image, or whether to further employ the image recognition processing to the pre-processed image. For example, a histogram of the original image may be analyzed by the control unit 20 to determine the degree of clarity and contrast in the original image. For example, a number of adjacent intensities of the histogram may be sampled to determine the average contrast between the sampled intensities and/or the gradients of a sampling of edges of the image may be considered to determine the clarity of the image. If the clarity and/or contrast is below a threshold amount, the control unit 20 initiates some or all of the weather-related processing. The same histogram analysis may be performed, for example, on the pre-processed image to determine whether the additional image recognition need be performed on the pre-processed image, or whether the pre-processed image can be directly displayed. By using image recognition processing only when the weather conditions are such that the pre-processed image generated requires it, the time required for processing and displaying an improved image is minimized.

Although illustrative embodiments of the present invention have been described herein with reference to the accompanying drawings, it is to be understood that the invention is not limited to those precise embodiments. For example, although the weather condition focused on above was snowflakes that comprise a snowfall, the same or analogous processing may be applied to the raindrops comprising a rainfall. In addition, the image recognition processing described above may be applied directly to the filtered image, without application of histogram equalization processing to the filtered image. Thus, it is intended that the scope of the invention is as defined by the scope of the appended claims.

What is claimed is:

1. A system for displaying a driving scene to a driver of an automobile, the system comprising: a) at least one camera having a field of view and facing in the forward direction of the automobile and capturing images of the driving scene, the images comprised of pixels of the field of view in front of the automobile, b) a control unit that receives the images from the camera and applies a salt and pepper noise filtering to the pixels comprising the received images, the filtering improving the quality of the image of the driving scene received from the camera when degraded by a weather condition and c) a display that receives the images from the control unit after application of the filtering operation and displays the images of the driving scene to the driver.

2. The system as in claim 1, wherein the salt and pepper noise filtering applied by the control unit is a median filter.

3. The system as in claim 1, wherein the salt and pepper noise filtering applied by the control unit is a SUSAN filter.

4. The system as in claim 1, wherein the control unit further applies a histogram equalization operation to the intensities of the pixels comprising the filtered images, the histogram equalization operation further improving the quality of the images of the driving scene when degraded by the weather condition.

5. The system as in claim 4, wherein the control unit further applies image recognition processing to the images following the histogram equalization operation.

6. The system as in claim 5, wherein the control unit applies image recognizing processing to the images to identify objects therein of at least one predetermined type.

7. The system as in claim 6, wherein objects of the at least one predetermined type comprise at least one selected from the group of: pedestrians, other automobiles, traffic signs, traffic controls, and road obstructions.

8. The system as in claim 6, wherein objects of the at least one predetermined type identified in the images are enhanced by the control unit for display by the display.

9. The system as in claim 6, wherein the control unit further identifies features in the images of at least one predetermined type.

10. The system as in claim 9, wherein the features of at least one predetermined type identified in the images are enhanced by the control unit for display by the display.

11. The system as in claim 9, wherein the features of at least one predetermined type comprise borders of the roadway.

12. The system as in claim 1, wherein the display is a head-up display (HUD).

13. The system as in claim 1, wherein the control unit further applies image recognition processing to the images following the filtering.

14. A method of displaying a driving scene to a driver of an automobile, the method comprising the steps of: a) capturing images of the driving scene in the forward direction of the automobile, the images comprised of pixels of the field of view in front of the automobile, b) salt and pepper noise filtering the pixels comprising the captured images, the filtering improving the quality of the images of the driving scene captured when degraded by a weather condition and c) displaying the images of the driving scene to the driver after application of the filtering operation.

15. The method as in claim 14, wherein the step of salt and pepper noise filtering of the pixels comprising the images is followed by the step of applying a histogram equalization to the filtered pixels.

16. The method as in claim 14, wherein the step of salt and pepper noise filtering of the pixels comprising the images is followed by the step of applying image recognition processing to the filtered pixels.
